(19) United States
(12) Patent Application Publication
(10) Pub. No.: US 2007/0247350 A1
(43) Pub. Date: Oct. 25, 2007

(54) Method and apparatus of compressing terrain data

(76) Inventor: Dean E. Ryan, Dublin, OH (US)

Correspondence Address: HAMILTON, BROOK, SMITH & REYNOLDS, P.C., 530 VIRGINIA ROAD, P.O. BOX 9133, CONCORD, MA, 01742-9133, US

(21) Appl. No.: 11/729,968

(22) Filed: Mar. 29, 2007

Related U.S. Application Data
(60) Provisional application No. 60/786,917, filed on Mar. 29, 2006.

(51) Int. Cl. G01S 13/08; G08B 23/00; G01S 13/93; G01S 7/40

(52) U.S. Cl. 342/65; 342/195; 342/123; 342/165; 342/29; 340/970

(57) ABSTRACT

A method and apparatus for reformatting terrain data that in turn increases compressibility of the terrain data. The method includes storing each sample of terrain data as a signed integer offset in hundreds of feet from a previous sample of terrain data; compressing the each sample of terrain data using RLE compression; and further compressing each sample of terrain data using Huffman compression. The signed integer offsets may be mapped to unsigned integer offsets from a minimum elevation to further reduce storage requirements.

### RELATED APPLICATIONS

This application claims the benefit of U.S. Provisional Application Ser. No. 60/786,917, filed on Mar. 29, 2006, the entire teachings of which are incorporated by reference.

### BACKGROUND

Before determining the amount of storage actually required in a terrain data system, it is necessary to review the size of the database and evaluate how susceptible the data is to being compressed. This will yield a fairly accurate picture of the storage requirements.

The size of a Digital Elevation Models (DEM) or other terrain data storage format is roughly 484 gigabytes. This is obviously too much data to store in a small airborne instrument, so some form of data compression is needed.

A first method attempted was a Run Length Encoding (RLE) scheme. This yielded reasonable results (as high as 70%-80% compression), but would fail on models depicting rough terrain, such as the Rocky Mountains.

A second method attempted was Huffman coding. This method worked very well for such a simple algorithm, frequently yielding results of around 90% compression. It was found that the models depicting rough terrain resulted in poor performance, but not as poor as RLE.

If the data can only be compressed by about 90%, it will be necessary to use some mechanical storage media. However, such a storage device in the vibration rich and oxygen poor aircraft environment would be highly complex. If on the other hand, one can compress the data by about 99% it may be possible to use solid state memory.

### SUMMARY OF THE INVENTION

The invention relates to a first step of data compression, wherein data is reformatted in files as a minimum elevation in feet with each data sample being stored as a one-byte unsigned integer offset in hundreds of feet from that minimum elevation. This essentially reduces the storage requirements by 50% since only a single byte is used per sample instead of two bytes.

After this first step of data compression, several high-performance data compression methods may be used to compress the data down to an acceptable size. Run Length Encoding (RLE) is one possible high-performance data compression method. Huffman coding (or modified Huffman coding) is a second possible high-performance data compression method. Elias Gamma coding and Elias Delta coding are two additional possible high-performance data compression methods.

In a preferred embodiment, a computer method and apparatus reformat terrain data in a manner that increases the amount of redundancy in the terrain data. Next the invention system stores each sample of terrain data as a signed integer offset from a previous sample of terrain data. The signed integer offsets may be mapped to unsigned integer offsets relative to a minimum elevation. The invention method and apparatus compress the reformatted terrain data using at least one of: RLE, Huffman coding, modified Huffman coding, Elias Gamma coding, and Elias Delta coding.

### BRIEF DESCRIPTION OF THE DRAWINGS

The foregoing will be apparent from the following more particular description of example embodiments of the invention, as illustrated in the accompanying drawings in which like reference characters refer to the same parts throughout the different views. The drawings are not necessarily to scale, emphasis instead being placed upon illustrating embodiments of the present invention.

FIG. 1 shows an overview of the major functional components of a terrain awareness system embodying the present invention.

FIG. 2 is a schematic illustration of tile loading of the database in the system of FIG. 1.

FIG. 3 is an illustration of the worst case overloading of the database.

FIG. 4A is a schematic illustration of the Snake compression algorithm of the present invention.

FIG. 4B is a schematic illustration of an alternative compression algorithm of the present invention.

FIG. 5 is a block diagram of a computer node in embodiments of the present invention.

### DETAILED DESCRIPTION OF THE INVENTION

A description of preferred embodiments of the invention follows.

The present invention relates to a method for reformatting terrain data that does not decrease the information of the database, but allows the other compression algorithms to perform better. The basic premise of lossless compression algorithms, such as RLE, Huffman coding, Elias Gamma coding, and Elias Delta coding, is the reduction or removal of redundancy from the data. Since terrain generally does not change abruptly, it was found that the amount of redundancy in the terrain data could be increased by storing each sample as a signed integer offset in hundreds of feet, or some other pre-assigned increment, such as sixteen feet or thirty-two feet, from the previous sample. The increase in redundancy comes from the fact that terrain will rarely change more than a few hundred feet in a short distance, thus most of the sample values for a terrain model will lie in the range of around −5 to +5. Now since the database is highly redundant, containing mostly small signed numbers, the two compression algorithms, such as RLE, Huffman coding, Elias Gamma coding, and Elias Delta coding, yield much higher compression ratios. For example, when data is compressed using RLE followed by Huffman, compression ratios from around 94% for extremely rough terrain to better than 99% for terrain with only mild variations are achievable.

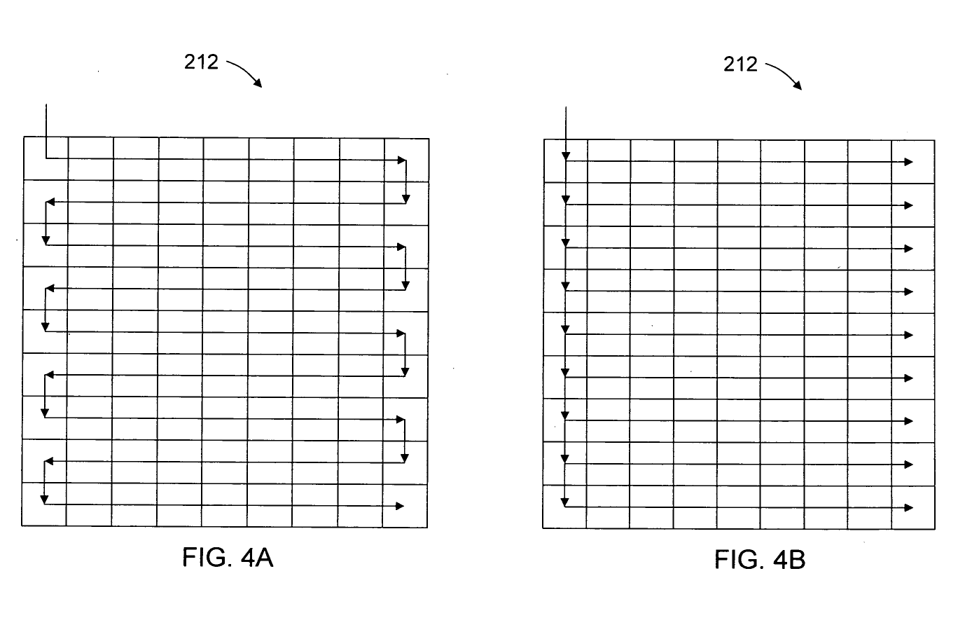

This compression method of transforming raw terrain altitude data into terrain difference data is accomplished using an algorithm nick-named Snake coding, since it is like a snake slithering along the terrain's contours. The Snake coding, illustrated in FIG. 4A, proceeds from one corner of a grid across the first row, then down to the next row and back across that row to the side of the grid the process started on. The algorithm proceeds back and forth across the grid and down one row at a time until all rows have been encoded. During the Snake coding process, the value of past data points must be tracked to ensure accurate representation in the resulting “delta” data. For example, suppose that the Snake coding is using increments of 16 feet and a particular row of data starts at an altitude of 1,000 feet and each data point thereafter is 2 feet higher. If the Snake coding solely based the value of the data point on the change from the previous value, then the entire row of data points would have values of zero. However, by tracking the data across several points, the Snake coding will recognize that the points are cumulatively reaching a threshold where a delta value of 1 is required. In the above example, the first point has an altitude of 1,000 feet, the second point has an altitude of 1,002 feet, and the fourth point has an altitude of 1,008 feet. The increase of 8 feet by the fifth data point, since it is halfway to the 16 foot increment, may trigger the delta value for the fifth point to change from zero to one. It can be helpful to store some information at the beginning of the compressed file indicating a “base” elevation from which you are starting, and perhaps the overall scale of the deltas. By storing the scale of the deltas it permits even higher degrees of compression for relatively flat terrain by reducing the number of bits required to store the deltas.

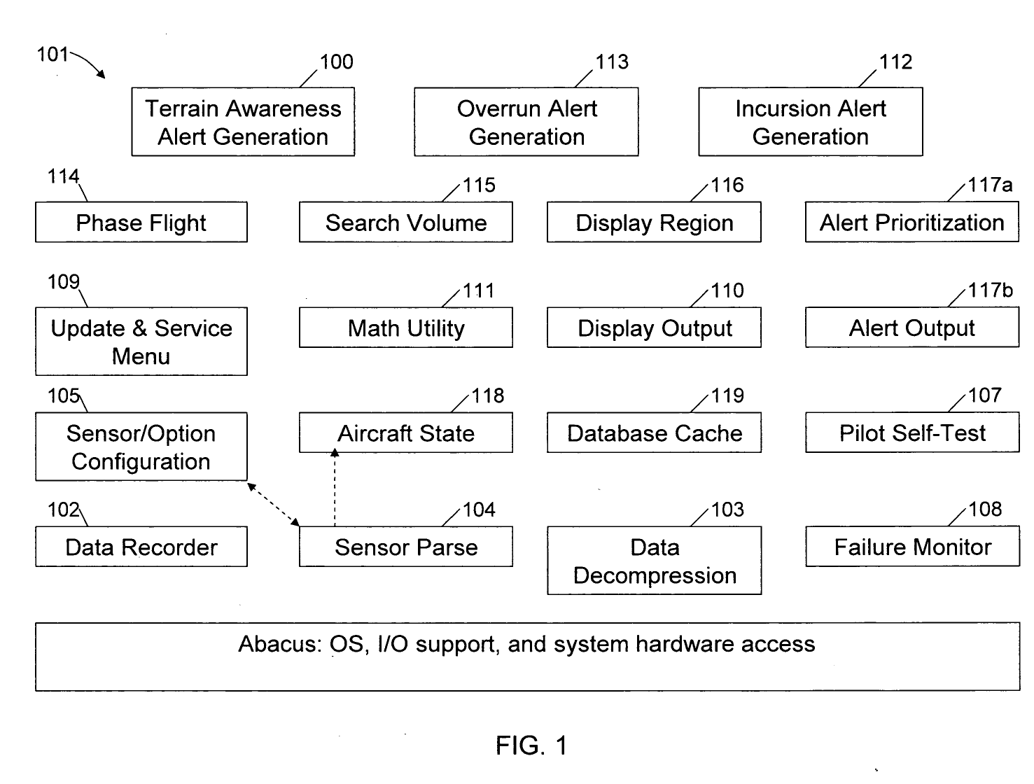

FIG. 1 shows an overview of the major functional components of a terrain data system 101 of the present invention. The present invention requires low-level software components to support the high-level function of the major components. The software system of the present invention defines the interfaces and behavior of each of the low-level software components comprising the architecture. Thus, traceability is maintained from the system (high-level) requirements to the low-level requirements.

The major architectural components or module requirements of the software system 101 of the present invention as shown in FIG. 1 is described in detail below. The modules include: Terrain Awareness Alert Generation module 100; Runway Incursion Alert Generation module 112; Runway Overrun Alert Generation module 113; Phase of flight module 114; Search volume computation module 115; Display Region computation module 116; Alert Prioritization and Annunciation module 117; Aircraft State module 118; Terrain, Obstacle, and Runway Database Cache module 119; Display Data Output module 100; and Mathematical and Navigational Utilities module 111.

The level of detail in each section is sufficient for implementation to be completed without undue experimentation by one skilled in the art. The inputs and outputs are defined, and the required behavior, including side effects, is defined. Where the component is a task, its observable behavior is described, and where the component is a callable function set, the function names, parameters and return values are described.

The Terrain Awareness Alert Generation module (AlertGen) 100 is a task that updates an alert state at least once each second. There are two kinds of alerts that can be generated, stateless and predictive. For predictive alerts, AlertGen 100 performs the following: Each second it enumerates the terrain posts within the search volume (i.e., those terrain/obstacle elevations that are predicted to be close to the aircraft within the next 60 seconds, based on current aircraft trajectory), and it compares those elevations and predicted aircraft state against the requirements for the predictive alerts. Predictive alerts are: 1) level flight Required Terrain Clearance (RTC) and 2) Imminent Terrain Impact (ITI). Stateless alerts are alerts that are generated by examining (e.g. once each second) only instantaneous values, not predicted values, because the ‘forward-looking’ component of the alert is already built in to the alert curves. Stateless alerts are: descending flight RTC and ITI, Premature Descent Alerts (PDA), and GPWS alert modes 1 and 3. Altitude callouts are also stateless and computed by AlertGen 100, but are informational only, and not considered Warnings or Cautions.

The Runway Incursion Alert Generation module (AlertGenRI) 112 computes alerts and solicited position updates when the phase of flight is ‘Taxi’. The module 112 includes a pair of functions called in the context of the AlertGen module 100. One function is called at least once each second for alerts, and the other one is called when the pilot requests a solicited position update by pressing a button or other actuator.

The Runway Overrun Alert Generation module (AlertGenRO) 113 computes alerts and solicited position updates when the phase of flight is ‘Landing’ or ‘Touchdown’. The module 113 includes a pair of functions called in the context of the AlertGen module 100. One function is called at least once each second for alerts, and the other one is called when the pilot requests a solicited position update by pressing a button or other actuator.

The Phase of flight module 114 computations are important to the invention system 101 because the specific values of distance, altitude, and sink rate used to compute the alert curves are mainly dependent on phase of flight. Also, phase of flight module 114 determines whether system terrain alerts (via 100) are to be generated or Runway Overrun or Incursion alerts (of modules 113, 112 respectively). It is also used to suppress nuisance alerts while in flight. The phase of flight module (FlightPhase) 114 has as its interface one public function. This function takes a single parameter that represents relative seconds from the current time. The FlightPhase module 114 takes this parameter and passes it to Aircraft State 118 (which extrapolates the aircraft state out to that time), queries database, and determines the aircraft position and velocity relative to the nearest runway. This function is called by AlertGen 112 to determine the appropriate set of alerts and the values to use when computing them. In every second of real time, it is called in ascending time order from 0 (i.e., now) to 59 seconds in the future to estimate the phase of flight for use by the predictive alerts.

The Search volume computation module (SearchVol) 115 is responsible for updating, once each second, a set of terrain and obstacle elevations that correspond to a region around the aircraft's projected flight path. These elevations will be checked by AlertGen 100 to determine if there should be an alert. This module 115 consists of one public function, called once a second by AlertGen 100, that assembles from the database cache 119 the elevation values along the extrapolated flight path returned by AircraftState 118 .

The Display Region computation module (DisplyRgn) 116 assembles the data from the terrain, obstacle, and runway database cache 119 needed to update the display. The module 116 consists of one public function that is called by the DisplayOutput task 110 periodically as it prepares the data stream required by the external display.

The Alert Prioritization and Annunciation module (AlertOutput) 117a, 117b takes the output from AlertGen 100, prioritizes any simultaneous alerts, and drives the audio and discrete alert outputs. It also interacts with the data recorder module 102 to store the computed alerts and to record their annunciation (e.g. date and time of annunciation.)

The Aircraft State module (AircraftState) 118 is a task that receives parsed sensor data from all configured and operational position, heading, altitude, and temperature sources. A sensor parse submodule 104 receives sensor data and parses (or otherwise preprocesses) that data for use by Aircraft State module 118 . It 118 also receives the state of all discrete inputs such as weight on wheels. It filters, corrects, blends, and correlates the received information to produce an accurate representation of the aircraft's actual position, velocity, and acceleration vectors. The computed set of data is made accessible to other modules in the system 101 via a set of public functions in the module 118. A sensor/option configuration module 105 allows for initiating, maintaining, and updating sensors and sensor data in the system 101.

The Terrain, Obstacle, and Runway Database Cache module (DBCache) 119 is a task responsible for prefetching information from the database and deciding which information is to be kept in its fixed-sized cache. The data is read by SearchVol module 115 and DisplayRgn 116.

The Terrain, Obstacle, and Runway Database Decompression module (DBExtract) 103 is a set of functions called by DBCache 119 to retrieve blocks of data from the MultiMediaCard storage device via the files system and decompress them.

The Display Data Output module (DisplayOut) 110 is the task responsible for taking the data from DisplyRgn module 116, formatting it into data appropriate to the type of configured display(s), and outputting it through the appropriate communication device (e.g. display monitor, speakers, etc.).

The Mathematical and Navigational Utilities module (MathUtil) 111 is a set of utility functions callable by other modules in the system 101 to solve common geometric, mathematical, or navigational problems, like point-line intersection testing, digital filtering, or great circle distance, as examples.

Other components in system 101 include a pilot self-test 107, failure monitoring and recovery 108 and service log (and corresponding user interface) 109 as known in the art.

Run-Time Considerations for the Terrain Database

It is a design goal of the terrain data system 101 to support very high speed aircraft. For this reason, a target maximum speed of 900 kts was chosen. At 900 kts an aircraft covers 15 miles per minute. Since the terrain awareness of system 101 has a maximum look-ahead alert time of 1 minute, at any given time the unit must have at least 15 miles of terrain loaded.

The terrain database 119 preferably has constant sized tiled regions of data to facilitate locating the source of the data and to simplify loading. With this approach, an entire tile can simply be located on the storage medium and loaded in its entirety. Storing the elevations in row/column form along lines of latitude and longitude with equal angular distance between elevation values makes the determination of source tile data location the and elevation lookup trivial. Since at high or low latitudes the constant angular sized tiles become narrower in linear distance, the extreme cases need to be considered to ensure the maximum desired speed can be supported. Based on observed compression rates and Secure Digital (SD) card bandwidth, the tiles take, on average, slightly less than half a second to load and decompress the data and to verify the Cyclic Redundancy Check (CRC).

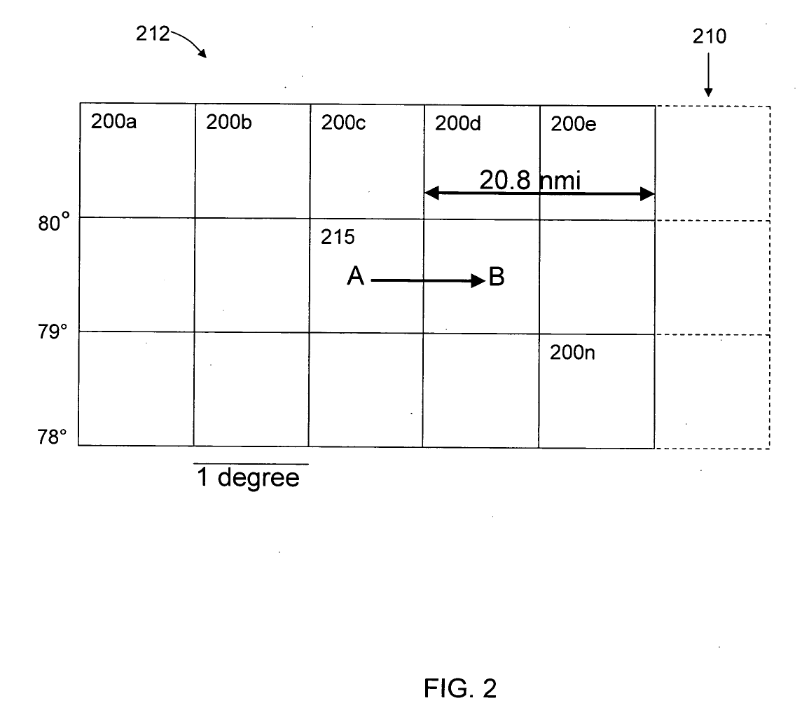

FIG. 2 shows tile loading of the database 119. At 80° north latitude, a 1° by 1° tile is 60 nautical miles tall and 10.4 miles wide. If we load the tiles 200a,b, . . . n in a 5×3 grid 212 (generally tile cache), centered on the current location, then we ensure that up to 80°, there is always enough data loaded to provide alerts up to the maximum speed. System 101 accomplishes this by noting that if the aircraft leaves the center tile 215 marked A, say going to the right, and as soon as it crosses out of tile A (center tile 215) and into tile B, then begin loading the column 210 of tiles outlined in dashed lines. Since we need 15 miles and already have 20.8 miles, the aircraft can cover 5.8 miles before the invention system 101 requires the newly fetched data. At 900 kts and heading straight east, this allows 23.2 seconds to load the new tiles 210. At 82°, we have 6.8 seconds. Above this latitude, the pair of tiles 200d,e to the right of the center tile 215/tile A is less than 15 miles wide. This means that we either have to lower the maximum speed supported, or else treat the polar caps as a special case. In the north, this is not a problem, since there is no terrain above 83°. At 83°, we have 5.8 seconds to load the tiles 210 if we only want to support 800 kts, which should be no problem. Above 83°, system 101 reports all elevation values as Mean Sea Level (MSL), so there is no data to load. Over Antarctica, however we need special handling and define a polar cap tile with a different sampling means, to be pre-loaded above a target latitude.

Since degrees of latitude are constant linear distance, moving north or south is never a problem: the 1° tile is always 60 nmi tall, so there are 3 minutes available at 900 kts before the next tile to the north is needed after subject aircraft leaves the center tile 215.

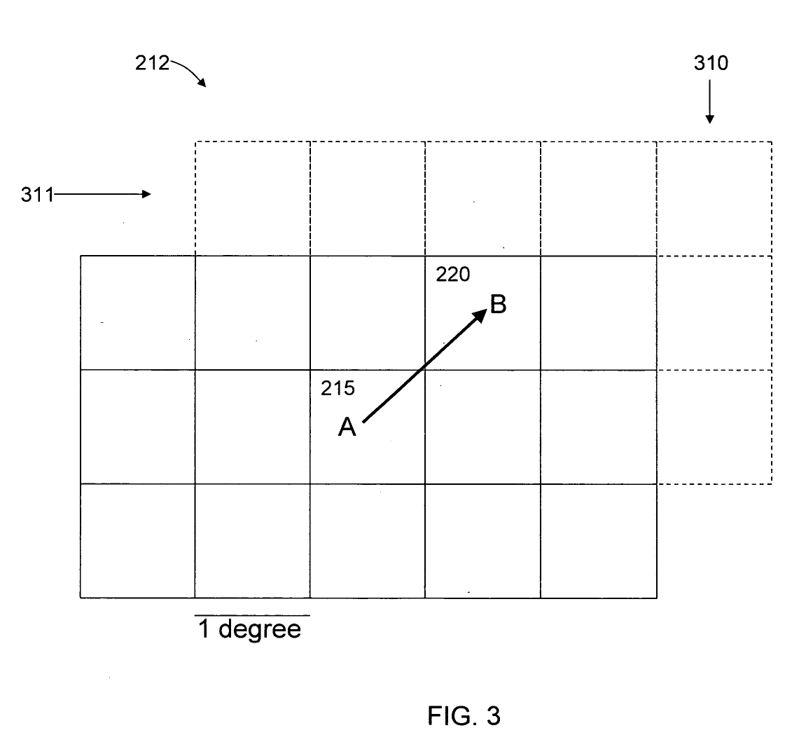

As shown in FIG. 3, when the aircraft moves diagonally the worst case for data volume is observed since a row 311 and a column 310 in the tile cache 212 need to be populated. System 101 uses this as a rule of thumb for worst case timing estimates: At an average estimated load time of 440 milliseconds, this entire operation should take just over 3 seconds.

Preprocessing Considerations for the Terrain Database

The terrain geographical information system (GIS) provides the information for the tiles 200 in 1° by 1° files named “<n/s><lat><w/e><lon>.bil” where the lat/lon are the coordinates of the top left (northwest) corner of the tile 200. These files are signed integer binary elevation values referenced to the Earth Geopotential Model EGM96 value of MSL. These are then compressed for use by terrain awareness module 100 and other modules of system 101, and written to an SD card. On the card, the files are organized into directories that follow a naming convention indicating direction and degree of latitude (e.g., n90 . . . s89), with each file for that latitude band in the appropriate subdirectory.

The source .bil file can be in different source resolutions: currently 6 or 30 arcseconds. Which implies 600×600 or 120×120 elevation values. Each file has either 8 or 16 bits for each elevation. The files go through the following steps during preparation and compression:
1. The first step in the processing is to read a file into memory where each elevation value is then held in 16 bits.
2. The elevation values are then scaled down by a factor supplied to the compression tool. One embodiment employs 16 feet scale for 6 arcsecond and 32 feet for 30 arcsecond. When the file is uncompressed and unscaled, half the scale is added back, ensuring no loss of vertical resolution in excess of half the scale: 8 feet for 6 arcsecond data and 16 feet for 30 arcsecond. At this stage, any special‘water’ values that denote Global 30 Arc-Second Elevation (GTOPO30) dataset ocean values are turned into MSL-0.
3. A Cyclic Redundancy Check (CRC) is then computed for storing into the file before compressing the data. Since this CRC is computed before compression, verifying the CRC at load time not only ensures the file was loaded without error, it also verifies the decompression.
4. Each value in the tile 200 is replaced with the difference between it and a neighbor. This is done to eliminate as much redundant information in the file as possible, to take advantage of the fewer bits it takes to represent the smaller number, and to create a range of values with desired statistical properties, i.e., a mean and median of zero and a Normal distribution. The original ‘snake’ algorithm is depicted in FIG. 4A. FIG. 4B is a variation that is used in some embodiments of the present invention. It benefits from the same 2-D correlation as the original, connecting the deltas in columns as well as rows, but also benefits by keeping all memory accesses in ascending order (first row left to right, then second row left to right, and so on), which improves speed during compression and decompression. The compression ratio should be unchanged between the two approaches.
5. The resulting difference values are in the form: [min, . . . , −2, −1, 0, 1, 2, . . . , max] with 0 as the most frequently appearing value, and a decreasing probability of occurrence as the magnitude of the difference increases. If we map these values onto the positive integers, we can take advantage of two forms of ‘Elias’ encoding to compress them nearly optimally. We use the following integer mapping:
   delta: 0, 1, −1, 2, −2, 3, −3, 4, −4, . . .
   representation: 1, 2, 3, 4, 5, 6, 7, 8, 9, . . .
      The following description of the two Elias encodings are from http://www.cs.tut.fi/˜albert/Dev/pucrunch/packing.html':
      Elias Gamma Code

The Elias gamma code assumes that smaller integer values are more probable. In fact it assumes (or benefits from) a proportionally decreasing distribution. Values that use n bits should be twice as probable as values that use n+1 bits.

In this code the number of zero-bits before the first one-bit (a unary code) defines how many more bits to get. The code may be considered a special fixed Huffman tree. You can generate a Huffman tree from the assumed value distribution and you'll get a very similar code. The code is also directly decodable without any tables or difficult operations, because once the first one-bit is found, the length of the code word is instantly known. The bits following the zero bits (if any) are directly the encoded value.

| Gamma Code | Integer | Bits |
|---|---|---|
| 1 | 1 | 1 |
| 01x | 2-3 | 3 |
| 001xx | 4-7 | 5 |
| 0001xxx | 8-15 | 7 |
| 00001xxxx | 16-31 | 9 |
| 000001xxxxx | 32-63 | 11 |
| 0000001xxxxxx | 64-127 | 13 |
| . . . | | |

Elias Delta Code

The Elias Delta Code is an extension of the gamma code. This code assumes a little more ‘traditional’ value distribution. The first part of the code is a gamma code, which tells how many more bits to get (one less than the gamma code value).

| Delta Code | Integer | Bits |
|---|---|---|
| 1 | 1 | 1 |
| 010x | 2-3 | 4 |
| 011xx | 4-7 | 5 |
| 00100xxx | 8-15 | 8 |
| 00101xxxx | 16-31 | 9 |
| 00110xxxxx | 32-63 | 10 |
| 00111xxxxxx | 64-127 | 11 |

The delta code is better than gamma code for big values, as it is asymptotically optimal (the expected codeword length approaches constant times entropy when entropy approaches infinity), which the gamma code is not. What this means is that the extra bits needed to indicate where the code ends become smaller and smaller proportion of the total bits as we encode bigger and bigger numbers. The gamma code is better for greatly skewed value distributions (a lot of small values).

For high-resolution data where the adjacent measurements are nearby to each other (e.g., 6 arcsecond), Elias Gamma encoding is generally more terse. For lower resolution (e.g., 30 arcsecond) data, the best mechanism depends on the roughness of the terrain. For this reason, the 30 arcsecond data is compressed with both mechanisms and the smaller output file is used.
6. For files that have little terrain variation, i.e. many of the difference values are 0, Elias encoding results in long strings of ‘1’ bits. The more successful the Elias compression is, the more and longer of these strings result. For this reason, each Elias encoding step is followed by run-length encoding (RLE). If the RLE step results in a smaller file, the output from that step is used. The RLE representation used is one run-length byte 1 followed by a replacement value c. If the value c is zero, then 1 bytes following are read unchanged. Otherwise the replacement value c is just repeated 1 times. Zero is a good choice for the non-replacement value since the Elias encoding will never produce a run of zeros longer than that necessary to outweigh the overhead of replacement (four bytes).

The preceding six steps are applied to compress the source data. These result in 80 84% compression ratios, depending on the source data, with very little (and perfectly bounded) loss of vertical resolution, and no loss of horizontal resolution. Each kind of compression applied, the source data horizontal resolution, and the vertical scale factor are all stored in a short file header along with the CRC. When loading the files at run-time, the reverse steps are applied and the final result is loaded into memory in a 6 arcsecond representation (up-sampling any 30 arcsecond data as needed) so that the alert algorithms have a consistent view of the terrain without regard for the source data.

Compression Terrain File Format for the Terrain Database

In the preferred embodiment of the present invention, the terrain files have the following format:

| File byte offset | Field Description |
|---|---|
| 0 (4 MSBs) | Horizontal resolution |
| 0 (4 LSBs) | Compression types |
| 1 | 32-bit CRC |
| 5 | Vertical resolution |
| 6 | 16-bit base tile elevation |
| 8 - end of file | Compressed data |

The first byte of the files holds the source resolution in the most significant four bits, and the compression type flags in the next four bits. They are encoded as follows:

| Code | Value | Resolution |
|---|---|---|
| RES_30_ARCSECONDS | 0 | 30 arcseconds (1 km) |
| RES_6_ARCSECONDS | 1 | 6 arcseconds (180 m) |

The next four bits hold the compression types that have been applied. If more than one type has been applied, the values are Or'd together. They are as follows:

| Code | Value | Compression Type |
|---|---|---|
| COMP_ELIAS_DELTA | 0x01 | Elias Delta |
| COMP_ELIAS_GAMMA | 0x02 | Elias Gamma |
| COMP_RLE | 0x04 | RLE |

If RLE compression has been applied, then it starts from file offset 1. This means that if the RLE bit is set in the compression type field, then the un-RLE step must be applied before the CRC, vertical resolution or base elevation can be referenced.
If the resolution was specified as 30 arcseconds, then the data after decompression is 120 columns by 120 rows. If the resolution was 6 arcseconds, then the data is 600 by 600.

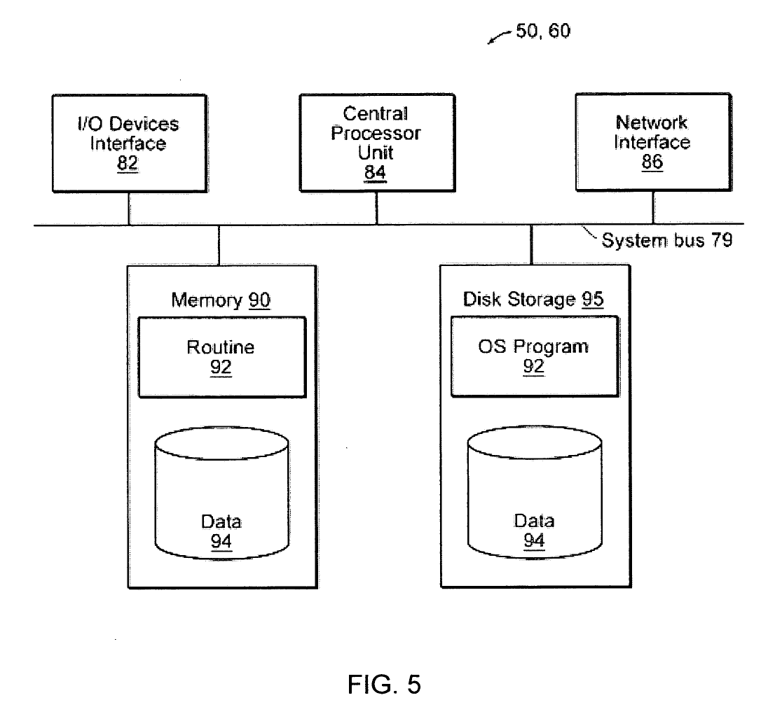

Embodiments of the present invention may be implemented in hardware, software, firmware or combinations thereof. A computer system implementing the above described features of the present invention may be configured as a single or plural processors, parallel processors, client-server networked computers and other computer configurations. Generally, any computer node implementing an embodiment of the present invention is as shown in FIG. 5.

FIG. 5 is a diagram of the internal structure of a computer (e.g., client processor/device 50 or server computers 60) for implementing a terrain awareness system or terrain data system 101 embodying the present invention. Computer 50, 60 contains system bus 79, where a bus is a set of hardware lines used for data transfer among the components of a computer or processing system. Bus 79 is essentially a shared conduit that connects different elements of a computer system (e.g., processor, disk storage, memory, input/output ports, network ports, etc.) that enables the transfer of information between the elements. Attached to system bus 79 is I/O device interface 82 for connecting various input and output devices (e.g., keyboard, mouse, displays, printers, speakers, etc.) to the computer 50, 60. Network interface 86 allows the computer to connect to various other devices attached to a network. Memory 90 provides volatile storage for computer software instructions 92 and data 94 used to implement an embodiment of the present invention (e.g., terrain data system 101, database 119, grid/tile cache 119 and corresponding loading process and compression method detailed above). Disk storage 95 provides non-volatile storage for computer software instructions 92 and data 94 used to implement an embodiment of the present invention. Central processor unit 84 is also attached to system bus 79 and provides for the execution of computer instructions.

In one embodiment, the processor routines 92 and data 94 are a computer program product (generally referenced 92), including a computer readable medium (e.g., a removable storage medium such as one or more DVD-ROM's, CD-ROM's, diskettes, tapes, etc.) that provides at least a portion of the software instructions for the invention system. Computer program product 92 can be installed by any suitable software installation procedure, as is well known in the art. In another embodiment, at least a portion of the software instructions may also be downloaded over a cable, communication and/or wireless connection. In other embodiments, the invention programs are a computer program propagated signal product embodied on a propagated signal on a propagation medium (e.g., a radio wave, an infrared wave, a laser wave, a sound wave, or an electrical wave propagated over a global computer network such as the Internet, or other network(s)). Such carrier medium or signals provide at least a portion of the software instructions for the present invention routines/program 92.

In alternate embodiments, the propagated signal is an analog carrier wave or digital signal carried on the propagated medium. For example, the propagated signal may be a digitized signal propagated over a global computer network (e.g., the Internet), a telecommunications network, or other network. In one embodiment, the propagated signal is a signal that is transmitted over the propagation medium over a period of time, such as the instructions for a software application sent in packets over a network over a period of milliseconds, seconds, minutes, or longer. In another embodiment, the computer readable medium of computer program product 92 is a propagation medium that the computer system 50 may receive and read, such as by receiving the propagation medium and identifying a propagated signal embodied in the propagation medium, as described above for computer program propagated signal product.

Generally speaking, the term “carrier medium” or transient carrier encompasses the foregoing transient signals, propagated signals, propagated medium, storage medium and the like.

Future Considerations for the Terrain Database In the “C/C++Users Journal” from March 2003, “Easy Analog Data Compression” article by Stephan Grünfelder, he performs very nearly the same steps as above to encode EEG/EKG signals, but without our RLE step. A main difference is his less-optimal use of a representation other than Elias for the encoded values. However, while we gain compression by throwing away low bits of the delta and thereby reducing the vertical resolution of the data, Grünfelder uses a predictor function, and rather than storing the deltas between measured values as we do, he stores the delta between the actual value and a predicted value, using the last three values to determine the slope (the prediction is linear). For data with runs of constant slope this seems nearly optimal, and is clearly lossless. So we would expect the high resolution NED data, for example, to compress well with this technique. For random or very flat data, this degenerates into our simple delta case, as would likely be the case with the coarse GTOPO30 data. This wouldn't allow us to increase our compression ratios significantly, but certainly could improve our vertical resolution while holding our compression ratio constant. A reason it might not improve compression is that the redundancy removed by using the predictor function is probably covered by our subsequent RLE encodeing, which Grünfelder does not use. This predictor technique might be related to Dynamic Markov Coding—it warrants future investigation.

Runway Database In other embodiments, system 101 sorts the runways in each region by High End longitude. Then when the system 101 compares the aircraft location against each runway, going west to east, the first time the system finds a runway where one end point is farther east than the east-most point of the bounding box that is centered on the aircraft and touches the closest known candidate runway, the system can stop looking. This embodiment also saves time by hyper-spacing to the first point in the list where some runway has some end that is west of the western side of the bounding box.

Preprocessing Considerations for the Runway Database OLD Approach:

In ArcGIS, select all obstacles east of 90° W longitude, export (all columns) as ‘.DBF’. Now switch selection to all obstacles at or west of 90° W longitude, and export as ‘.DBF’. This is necessary because a) ArcGIS does not allow the sorting we need, and b) Excel®, which allows the sorting, does not allow for more that 64K rows, and we have around 93K rows.

Using Excel®, in turn read each dbf file, add a column on the right and fill it with‘=INT(n)’ where n is the column with Long_DD. Now sort the whole sheet first by the new column, and secondly by Lat_DD. Save this as a .‘csv’. Repeat for the other file.

NEW Approach:

First note that in the above, the 5 manual steps required to import the obstacles into the GIS before beginning the rest are ignored. Now, obstpack.exe just, iterates over the regional obstacle fix-field text files, building a gigantic list in memory, sorts them as above (first by int(lon), then by lat), and exports the binary records in the proper byte order to be read into the system 101.

Acronyms

CFIT: Controlled Flight Into Terrain
EDM: Ryan International Engineering Development Methodology
FAA: Federal Aviation Administration
FLTA: Forward-Looking Terrain Avoidance
GPWS: Ground Proximity Warning System
ITI: Imminent Terrain Impact
PDA: Premature Descent Alert
RI: Runway Incursion
RO: Runway Overrun
ROC: Required Obstacle Clearance
RTC: Required Terrain Clearance
TAWS: Terrain Awareness & Warning System
TERPS: United States Standard for Terminal Instrument Procedures
TSO: Technical Standard Order

While this invention has been particularly shown and described with references to preferred embodiments thereof, it will be understood by those skilled in the art that various changes in form and details may be made therein without departing from the scope of the invention encompassed by the appended claims.

What is claimed is:

1. A computer method of compressing terrain data, comprising:
reformatting terrain data in a manner that increases amount of redundancy in the terrain data, said reformatting including storing each sample of terrain data as a signed integer offset from a previous sample of terrain data; and
compressing the reformatted terrain data using at least one of:
run length encoding (RLE);
Huffman coding;
modified Huffman coding;
Elias Gamma coding; and
Elias Delta coding.

2. The method of claim 1 wherein the signed integer offset is one of:
two feet;
four feet;
eight feet;
sixteen feet;
thirty-two feet;
sixty-four feet; and
one hundred and twenty-eight feet.

3. The method of claim 1 wherein storing each sample of terrain data as a signed integer offset from a previous sample of terrain data includes:
defining a block of terrain formed within a range of latitude and a range of longitude;
defining sampling points at spaced intervals of latitude and longitude within the defined block of terrain, resulting in rows and columns of sampling points;
determining a sampling point associated with one corner of the defined block of terrain as a starting location with a base elevation; and
recording differences in altitude between adjacent sampling points by starting at the determined sampling point associated with one corner of the defined block and recording altitude differences between the other sampling points in order by:
moving in one direction across a first row of sampling points;
moving in the opposite direction across a second row of sampling points; and
continuing to move across the remaining row s of sampling points in alternating directions until respective altitude differences for the sampling points within the defined block of terrain are recorded.

4. The method of claim 3 wherein the base elevation is one of an absolute altitude, a minimum elevation and an actual altitude.

5. The method of claim 1 wherein storing each sample of terrain data as a signed integer offset from a previous sample of terrain data includes:
defining a block of terrain formed within a range of latitude and a range of longitude;
defining sampling points at spaced intervals of latitude and longitude within the defined block of terrain, resulting in rows and columns of sampling points;
determining a sampling point associated with one corner of the defined block of terrain as a starting location with a base elevation; and
recording differences in altitude between adjacent sampling points by starting at the determined sampling point associated with one corner of the defined block and recording a respective altitude difference for each of the other sampling points in order by:
for each row, moving across the row of sampling points in a same direction and processing one row at a time in sequence; and
moving between rows from a first sampling point in one row to a first sampling point in a succeeding row, each of the first sampling points and the determined sampling point being in a common column.

6. The method of claim 5 wherein the base elevation is one of an absolute altitude, a minimum elevation and an actual altitude.

7. The method of claim 5 wherein the step of defining sampling points employs evenly spaced intervals.

8. The method of claim 1 further comprising, before compressing the reformatted terrain data, mapping the signed integer offsets to unsigned integer offsets, the unsigned integer offsets being relative to a minimum elevation.

9. A computer implemented method of presenting terrain information to an aircraft pilot, comprising:
(a) compressing terrain data by:
storing each sample of terrain data as a signed integer offset, from a previous sample of terrain data resulting in reformatted terrain data and;
compressing the reformatted terrain data using RLE compression and Huffman compression; and
(b) providing the compressed terrain data to at least one of:
a terrain awareness alert module;
a runway incursion alert module; and
a runway overrun alert module.

10. The method of claim 9 wherein the compressed terrain data is further made available to any of:
a phase of flight module;
a search volume computation module;
a display region computation module;
an alert prioritization and annunciation module;
an aircraft state module;
a terrain, obstacle, and runway database cache module;
a display data output module; and
a mathematical and navigational utilities module.

11. The method of claim 9 wherein step (a) compressing terrain data includes representing the reformatted terrain data as unsigned integer offsets from a minimum elevation.

12. The method of claim 9 wherein storing each sample of terrain data as a signed integer offset from a previous sample of terrain data includes:
defining a block of terrain formed within a range of latitude and a range of longitude;
defining sampling points at spaced intervals of latitude and longitude within the defined block of terrain, resulting in rows and columns of sampling points;
determining a sampling point associated with one corner of the defined block of terrain as a starting location with a base elevation, the base elevation being one of an absolute altitude, a minimum elevation and an actual altitude; and
recording differences in altitude between adjacent sample points by starting at the determined sampling point associated with one corner of the defined block and recording altitude differences between the other sampling points in order by:
moving in one direction across a first row of sampling points;
moving in the opposite direction across a second row of sampling points; and
continuing to move across the remaining rows of sampling points in alternating directions until respective altitude differences for the sampling points within the defined block of terrain are recorded.

13. The method of claim 9 wherein storing each sample of terrain data as a signed integer offset from a previous sample of terrain data includes:
defining a block of terrain formed within a range of latitude and a range of longitude;
defining sampling points at spaced intervals of latitude and longitude within the defined block of terrain, resulting in rows and columns of sampling points;
determining a sampling point associated with one corner of the defined block of terrain as a starting location with a base elevation, the base elevation being one of an absolute altitude, a minimum elevation and an actual altitude; and
recording differences in altitude between adjacent sampling points by starting at the determined sampling point associated with one corner of the defined block and recording a respective altitude difference for each of the other sampling points in order by:
for each row, moving across the row of sampling points in a same direction and processing one row at a time in sequence; and
moving between rows from a first sampling point in one row to a first sampling point in a succeeding row, each of the first sampling points and the determined sampling point being in a common column.

14. A computer apparatus for providing terrain information to a pilot of an aircraft, comprising:
a database of terrain data compressed by:
reformatting terrain data in a manner that increases amount of redundancy in the terrain data, said reformatting including storing each sample of terrain data as a signed integer offset from a previous sample of terrain data; and
compressing the reformatted terrain data using at least one of:
RLE;
Huffman coding;
modified Huffman coding;
Elias Gamma coding; and
Elias Delta coding;
means for determining location of an aircraft;
means for accessing samples of terrain data from the database of terrain data according to the determined location; and
means for providing the accessed samples of terrain data to a pilot of the aircraft, comprising at least one of:
a terrain awareness alert module;
a runway incursion alert module;
a runway overrun alert module;
a phase of flight module;
a search volume computation module;
a display region computation module;
an alert prioritization and annunciation module;
an aircraft state module;
a terrain, obstacle, and runway database cache module; and
a display data output module.

15. The apparatus of claim 14 wherein the signed integer offset is one of:
two feet;
four feet;
eight feet;
sixteen feet;
thirty-two feet;
sixty-four feet; and
one hundred and twenty-eight feet.

16. The apparatus of claim 14 wherein storing each sample of terrain data as a signed integer offset from a previous sample of terrain data includes:
defining a block of terrain formed within a range of latitude and a range of longitude;
defining sampling points at spaced intervals of latitude and longitude within the defined block of terrain, resulting in rows and columns of sampling points;
determining a sampling point associated with one corner of the defined block of terrain as a starting location with one of a minimum elevation, an absolute altitude and an actual altitude; and
recording differences in altitude between adjacent sampling points by starting at the determined sampling point associated with one corner of the defined block and recording altitude differences between the other sampling points in order by:
moving in one direction across a first row of sampling points;
moving in the opposite direction across a second row of sampling points; and
continuing to move across the remaining rows of sampling points in alternating directions until respective altitude differences for the sampling points within the defined block of terrain are recorded.

17. The apparatus of claim 14 wherein storing each sample of terrain data as a signed integer offset from a previous sample of terrain data includes:
defining a block of terrain formed within a range of latitude and a range of longitude;
defining sampling points at spaced intervals of latitude and longitude within the defined block of terrain, resulting in rows and columns of sampling points;
determining a sampling point associated with one corner of the defined block of terrain as a starting location with one of a minimum elevation, an absolute altitude and an actual altitude; and
recording differences in altitude between adjacent sampling points by starting at the determined sampling point associated with one corner of the defined block and recording a respective altitude difference for each of the sampling points in order by:
for each row, moving across the row of sampling points in a same direction, processing one row at a time in sequence; and
moving between rows from a first sampling point in one row to a first sampling point in a succeeding row but same column.

18. The method of claim 14 further comprising, before compressing the reformatted terrain data, mapping the signed integer offsets to unsigned integer offsets.

19. The method of claim 18 wherein the unsigned integer offsets are relative to a minimum elevation.

20. A terrain data system comprising:
means for reformatting terrain data in a manner that increases amount of redundancy in the terrain data, said reformatting means storing each sample of terrain data as a signed integer offset from a previous sample of terrain data; and
data compression means for compressing the reformatted terrain data using at least one of:
run length encoding (RLE);
Huffman coding;
modified Huffman coding;
Elias Gamma coding; and
Elias Delta coding.
